(19) United States
(12) Patent Application Publication
(10) Pub. No.: US 2010/0171482 A1
(43) Pub. Date: Jul. 8, 2010

(54) METHOD AND APPARATUS OF A MAXIMUM POWER POINT TRACKING CIRCUIT FOR SOLAR POWER GENERATION

(76) Inventors: YANG YE, Mississauga (CA); Sheng Tao, Waterloo (CA)

Correspondence Address: Yang Ye, 2802-310 Burnhamthorpe Rd. W, Mississauga, ON, L5B4P9, CA

(21) Appl. No.: 12/350,252

(22) Filed: Jan. 8, 2009

(51) Int. Cl. G05F 5/00

(52) U.S. Cl. 323/299

(57) ABSTRACT

A circuit that tracks the maximum power point of the solar cell is disclosed in the present invention. Unlikely conventional way of maximum power point tracking (maximum power point is referred to as MPP hereinafter; maximum power point tracking is referred to as MPPT hereinafter) which tracks MPP in the time frame of second or minutes, in the disclosed invention, MPP is tracked within the switching cycle, using the natural current ripple of the downstream converter circuit. The switching cycle is in the order of 10s of micro-seconds. Within the switching cycle of the converter, there is a natural current ripple which will result in the power change. The MPPT circuit tracks the power change and adjusts the current reference value accordingly to operate at MPP of the solar cell.

### BACKGROUND

1. Field of the Invention

The present invention relates to solar power generation, and more particularly to a method and apparatus of maximum power point tracking circuit for solar cell arrays.

2. Background Information

The simplified circuit model of the solar cell is shown in FIG. 1. It contains a current source Iph and a diode. Iph is dependent on the strength of solar light. Let I and V be the output current and voltage; Id and Vd be the current and voltage of the diode. According to the circuit schematic, the following equations can be written.

I=Iₚₕ−I_{d} (1)

V=V_{d} (2)

According to the diode characteristics, the following equation can be written.

$${I}_{d} = {I}_{s} ( {e}^{\frac{{V}_{d}}{{mV}_{T}}} - 1 ) \qquad ( 3 )$$

where Iₛ is the reverse saturation of the diode, which is a parameter of the diode and varies with temperature; m is a constant which is different between solar cell suppliers; V_{T} is the thermal voltage with the equation of:

$${V}_{T} = \frac{kT}{q} \qquad ( 4 )$$

where k is Boltzmann constant, which is 1.38*10̂(−23) J/K;
T is the absolute temperature in K;
q is the charge of an electron, which is 1.6*10̂(−19) C
   From Equations (1)˜(4), the closed form of I−V characteristic can be derived as

$$I = {I}_{ph} - {I}_{s} ( {e}^{\frac{qV}{mkT}} - 1 ) \qquad ( 5 )$$

A more practical circuit model of the solar cell includes the internal parasitic currents and the wiring resistance. The model is shown in FIG. 2. The differences from FIG. 1 are the series resistor Rs and the parallel resistor Rp, where Rs is very small and Rp is very large. According to the circuit schematic, the following equations can be written.

$$\begin{matrix}I = {I}_{ph} - {I}_{d} - {I}_{p} & ( 6 ) \\ {I}_{p} = \frac{{V}_{p}}{{R}_{p}} & ( 7 ) \\ {V}_{p} = {V}_{d} & ( 8 ) \\ V = {V}_{p} - {R}_{s} I & ( 9 )\end{matrix}$$

The diode characteristic is the same as in FIG. 1, which is

$${I}_{d} = {I}_{s} ( {e}^{\frac{{V}_{d}}{{mV}_{T}}} - 1 ) \qquad ( 10 )$$

where the parameters of Iₛ, m and V_{T} the same as in Equation (3).
From Equation (6)˜(10), the I−V characteristic of a practical solar cell can be derived as

$$I = {I}_{ph} - \frac{{R}_{s}}{{R}_{p}} I - \frac{V}{{R}_{p}} - {I}_{s} ( {e}^{\frac{q ( V \cdot R , I )}{mkT}} - 1 ) \qquad ( 11 )$$

Equations (5) and (11) show that environment factors play an important role in solar cell's I−V characteristics. The most important factors are temperature and the amount of solar light.

The typical output characteristic of the solar cell is shown in FIG. 3. The thick trace is the solar cell I−V curve. When the output current is 0, the output voltage reaches maximum, which is the open circuit voltage V_{OC}, as shown in FIG. 3; when the output voltage is 0, the output current reaches maximum, which is the short circuit current I_{SC}, as shown in FIG. 3. In both cases, the output power is 0. Each point in the trace represents one operating point of the solar cell. There is an operating point along the trace, which delivers most amount of the output power. The point is marked as MPP in FIG. 3. The coordinates of MPP are V_{MPP} and I_{MPP}. Since MPP relies heavily on the environment factors which cannot be pre-determined, there is no way to preset the operating point. It has to be adjusted during operation. That is why MPPT is so important in solar power generation.

There are many difference kinds of MPPT methods. The most well-known and popular methods are Perturb and Observe (hereinafter referred to as ‘P&O’), the Incremental Conductance (INC), and the Constant Voltage (CV) methods.

P&O method is most mature. The concept is to perturb the output voltage of the solar array and check how the output power changes. The property at MPP is that dP/dV=0. If dP/dV>0, it is known that more perturbation should be given in the same direction to move towards MPP; if dP/dV<0, then the perturbation direction should be reversed to move towards MPP. The method can be implemented in both hardware and software. The disadvantage of the method is that it may oscillate around the MPP in steady state operation. The response speed is usually not fast enough. If the environment condition changes rapidly, it may even track in a wrong way.

INC method is based on calculating the solar array's incremental conductance dI/dV. From dP/dV=0, it can be derived that dI/dV=−I/V. This method is similar to P&O. The method is only implemented in software.

CV method is based on the experience that the ratio of MPP voltage and the open circuit voltage is about 76%. So the solar array is periodically disconnected from the load to measure the open circuit voltage, and then set the operating point to be 76% of the measured open circuit voltage. This is easy to implement; however it is not preferred to disconnect the load periodically, and the MPP point is not always at 76% of the open circuit voltage.

Other methods try to combine the above three methods to get more accurate MPP tracking. However, there is still no optimum solution to the problem yet. It is desired to have a reliable and easy-to-implement method, which tracks MPP with fast response time and little disturbance to the system. Such a solution is disclosed in the present invention.

### SUMMARY OF THE INVENTION

The embodiments of the present invention are directed to the method and apparatus of MPPT circuit for solar cells. It is an improved P&O method.

In conventional P&O method, the perturbation is given after the average output power is measured. The perturbation is based on steady state power. Usually it perturbs the system once every several seconds. In order to have noticeable change in the average power, the perturbation has to reach enough strength. When it reaches steady state, it may oscillate around the MPP with considerable magnitude.

The present invention uses a different approach. In most of the solar power generation application, especially in grid-connected application, the solar cell is followed by a boost converter. The direct output of the solar cell is connected to an inductor, which makes the solar output current to be continuous. The boost converter is operating at a high switching frequency. So the solar cell output current is a dc current with ripples.

The present invention utilizes the natural current ripple to observe the direction towards MPP. The observation is done in every switching cycle, which is in the order of 10s of micro-seconds. The perturbation is given in the next switching cycle, with a very small step. Although each step size is small, since it is tracking continuously, the overall response time is much faster than the conventional method. In steady state operation, it oscillates one or two steps around MPP, but since the step size is small, the rest of the system can hardly notice the oscillation. Actually the result of the perturbation is much smaller than the effect of the natural current ripple.

In this way, it overcomes the problems in P&O method, and achieves fast tracking and low perturbation. The method is implemented in hardware. The hardware circuit is based on simple analog circuit blocks. It can be integrated into an integrated circuit to improve the reliability and to reduce the cost.

### BRIEF DESCRIPTION OF FIGURES

FIG. 1 shows the simplified circuit model for solar cells;

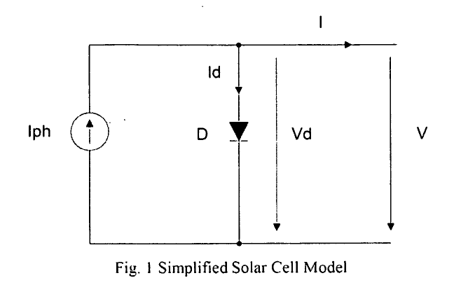

FIG. 2 shows the practical circuit model for solar cells;

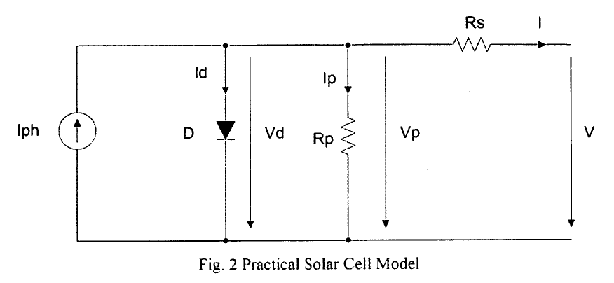

FIG. 3 shows a typical solar cell I-V characteristics;

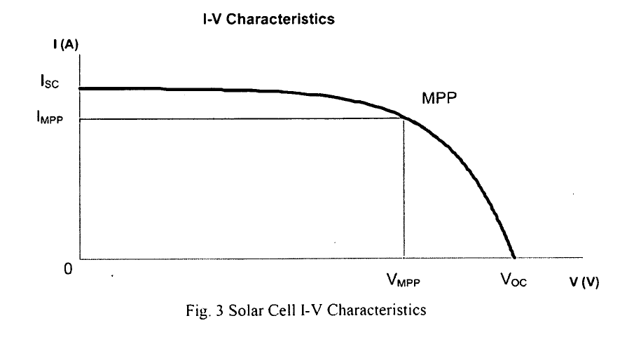

FIG. 4 shows a typical solar power converter system with MPPT control;

FIG. 5 shows the disclosed MPPT circuit block diagram in the present invention;

FIG. 6 shows the implementation example of ‘Controlled Incremental Circuit’ block for FIG. 5;

FIG. 7 shows the simulation results for Iin and Iref;

FIG. 8 shows the implementation example of ‘Switching Control’ block for FIG. 5;

### DETAILED DESCRIPTION OF THE PREFERRED EMBODIMENTS

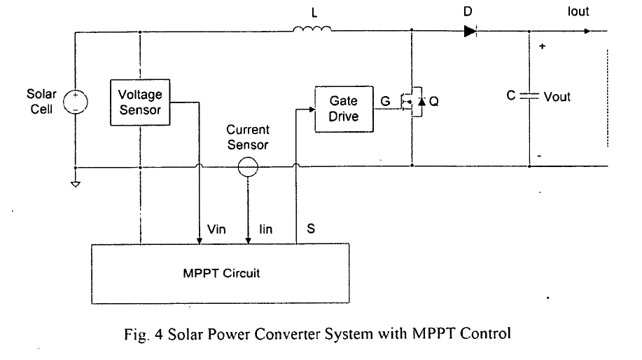

FIG. 4 shows the general first stage power circuit of a solar power generator with MPPT control. For most of the solar power generator, the first stage is a boost converter as shown in FIG. 4. It contains an inductor L. One end of the inductor L is connected to the positive terminal of the solar cell. The other end of the inductor L is connected to the anode of a diode and the drain of a MOSFET. The cathode of the diode is connected to the positive terminal of the bulk capacitor C and the positive terminal of the load. The source of the MOSFET is connected to the negative terminal of the bulk capacitor C, the negative terminal of the load, and the negative terminal of the solar cell. The downstream circuit is the load, which is at the right side of the capacitor C, and is expressed as the dashed line. It can be a DC/AC converter or a charge controller. No matter what topology is used in the downstream circuit, the main concern in the MPPT circuit is only to extract as much power as possible from the solar cell. The gate of the MOSFET is the control output of the MPPT circuit. There is a voltage sensor connected at the output terminals of the solar cell. The output of the voltage sensor is sent to the MPPT circuit. There is a current sensor connected in series with the solar cell. It can be a current sense resistor, a hall-effect sensor, or any kind of dc current sensor. The output of the sensor is sent to the MPPT circuit. The MPPT circuit received the outputs from the voltage and current sensors, and sends out the gating signal S to the drive circuit. The drive circuit receives the signal S and converts it to gate drive G for the MOSFET, and thus closes the control loop.

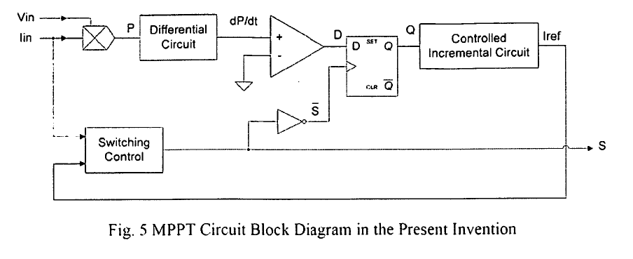

The block diagram of the present invention for MPPT circuit is shown in FIG. 5. The outputs of the voltage sensor and the current sensor, Vin and Iin, are connected as the inputs to the MPPT circuit. They are sent to an analog multiplier. The output of the analog multiplier is the instantaneous power P. P is passed on to a differential circuit to get the derivative dP/dt. dP/dt is sent to a zero cross comparator. The output of the comparator is a logic signal, named as D. The signal D is logic high if the instantaneous power P is increasing; and it is logic low if P is decreasing. The signal D is not sensed continuously. It is sampled only at the falling edge of the gate signal S.

The MOSFET in the power circuit is turning on and off periodically during each switching cycle. During the period when the MOSFET is on, the current is always increasing, which means dI/dt>0. At the end of the period, dI/dt is still greater than 0. At this moment, check the sign of dP/dt. If dP/dt>0, it indicates dP/dI>0, which means the output power is increased if the current is increased. As a result, the current reference Iref should be increased to get more power from the solar cell; if dP/dt<0, it indicates dP/dI<0, which means the output power is decreased if the current is increased. As a result, the current reference Iref should be decreased to get more power.

Therefore, the falling edge of the gate signal S serves as a clock signal to the D flipflop in FIG. 5. Since the D flipflop is usually triggered at the rising edge of its clock input, the actual clock signal is the inverse of the gate signal, which is S̅. The output of the D flipflop, Q, records the sign of dP/dt at the falling edge of the gate signal S.

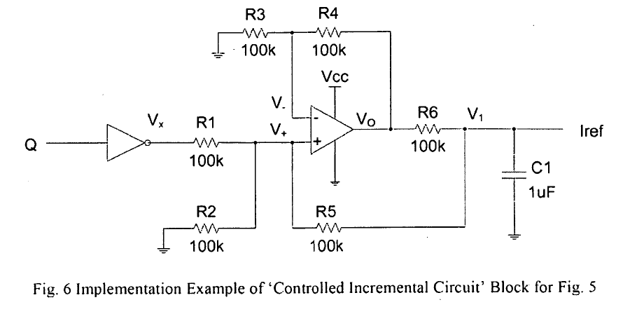

Q is passed on to the block called ‘Controlled Incremental Circuit’, which generates the current reference Iref. From the previous description, Q determines the change of Iref. When Q is logic high, Iref should increase by a small amount within one switching cycle; when Q is logic low, Iref should decrease by a small amount within one switching cycle. A circuit example to achieve the function is shown in FIG. 6.

In FIG. 6, there is an op-amp circuit with six identical resistors of 100 k each, and a capacitor of 1 uF. The input of the circuit is Q, and the output is Iref. Let the input voltage be V_{Q}, the output voltage be V₁, the op-amp terminal voltages be V₊, V₋ and V_{O}, for the positive, the negative and the output terminals. The power supply voltage is V_{cc}.

The circuit equations are

$$\begin{matrix}{V}_{O} = 2 {V}_{+} & ( 12 ) \\ {V}_{+} = \frac{{V}_{Q} + {V}_{1}}{3} & ( 13 ) \\ {C}_{1} \frac{d {V}_{c 1}}{d t} = \frac{{V}_{O} - {V}_{1}}{{R}_{6}} & ( 14 )\end{matrix}$$

From Equations (12)˜(14), it can be derived that

$${V}_{1} ( t ) = {V}_{1} ( {t}_{0} ) + ( \frac{2}{3} {V}_{Q} ( t ) - {V}_{1} ( {t}_{0} ) ) ( 1 - {e}^{- \frac{t}{3 {R}_{6} {C}_{1}}} )$$

Where t0 is the moment of falling edge of the gate signal for the main MOSFET.
V_{Q}(t)=V_{cc} when Q is logic high,
V_{Q}(t)=0 when Q is logic low.
   In this example, R6=100 k, C1=1 uF. In actual application, the capacitance value can be tuned according to the required response time. The main purpose of R6 is to limit the current and to keep C1 in a reasonable range.

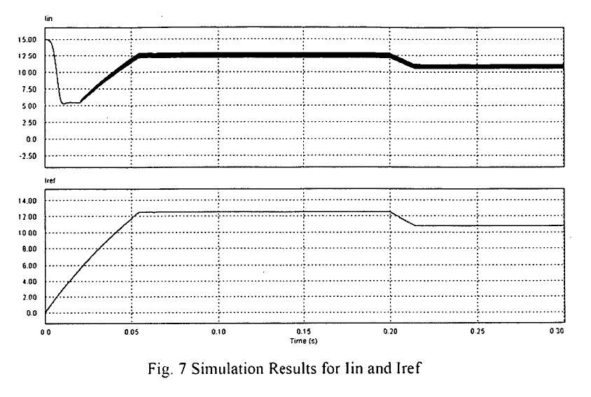

The simulation results with the above example are shown in FIG. 7. Iin is the input current from the solar cell in FIG. 4. Iref is the reference current generated with the MPPT circuit shown in FIG. 5 and FIG. 6. The whole system starts at time 0. Initially, there is an inrush to charge the output capacitor C in FIG. 4. The short circuit current of the solar cell is assumed to be 15 A. After the initial charge of the capacitor is over, Iref keeps ramping up to search for the MPP of the solar cell. After 0.05 second, MPP is reach, and the current reference stays almost constant, and the solar cell current is following the current reference with a small ripple. At 0.2 seconds, an environment change is simulated. The short circuit current of the solar cell is assumed to reduce to 13 A suddenly at 0.2 second. It can be seen that it takes the MPPT circuit less than 0.01 second to find the new MPP. Therefore, the method of tracking MPP at real time with fast response and almost no disturbance to the system is proven to be achievable.

The complete MPPT circuit as shown in FIG. 5 and FIG. 6 is composed of simple op-amp circuits and logic circuits. It can be integrated to a single integrate circuit to improve reliability and reduce cost.

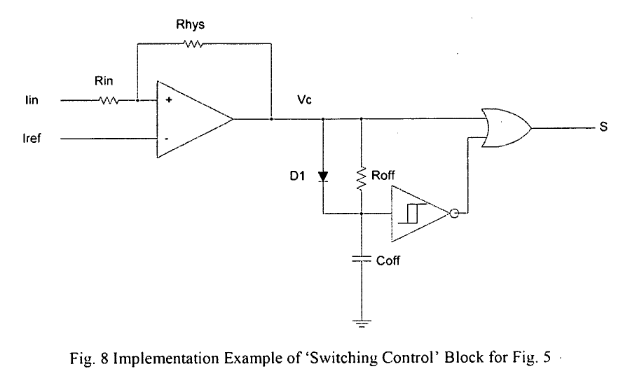

If making the MPPT circuit into an integrated circuit, the ‘Switching Control’ block in FIG. 5 can either be included or be removed. If it is to be included in the integrated circuit, FIG. 8 shows an example of tile implementation. Iin and Iref are sent to a hysteretic comparator, which is composed of the op-amp and two resistors, Rin and Rhys. The hysteretic band is set using the resistor Rhys. The output of the comparator Vc can be the switching signal. However, to ensure the switching can be continued all the time, a maximum off time is set using the circuit composed of the diode D1, resistor Roff, capacitor Coff, and the Schmitter trigger logic inverter. If Vc stays at low level for long time, the voltage of capacitor Coff will be discharged through Roff, which will lead to the output of the logic inverter becoming high. The logic OR of Vc and the output of the logic inverter becomes the switching signal S.

So a complete MPPT circuit example has a block diagram shown in FIG. 5, with the ‘Controlled Incremental Circuit’ block shown in FIG. 6, and ‘Switching Control’ block shown in FIG. 8.

The switching control block can also be outside of the integrated circuit, to facilitate other switching control circuit. In this case, simple disable the block shown in FIG. 8, and use external connection for switching signal S.

While exemplary embodiments described hereinabove, it should be recognized that these embodiments are provided for illustration and are not intended to be limitative. Any modifications and variations, which do not depart from the spirit and scope of the invention, are intended to be covered herein.

What is claimed:

1. A method and apparatus of a maximum power point tracking circuit for solar power generation, wherein the circuit relies on the natural current ripple to determine the direction towards the maximum power point, and updates the current reference in the next switching cycle according. With this method, minimal disturbance is given to the system, and fast response time is achieved.

2. The apparatus of claim 1, wherein a voltage sensor and a current sensor are used to monitor the solar cell voltage and solar cell output current. An analog multiplier is used to get the product of the voltage and the current, which is the solar cell output power. The derivative of the output power dP/dt is measured using a differential circuit. The sign of dP/dt is sensed using a zero-crossing comparator. The sign of dP/dt at the end of the turn on period of each switching cycle is latched using a D-flipflop, with the falling edge of the gate signal as the clock, and the sign of dP/dt as the input. The latched sign of dP/dt at the end of the turn on period of the switching cycle is passed to the ‘Controlled Incremental Circuit’ to determine if the current reference Iref need to be increased or decreased.
If the latched dP/dt is logic high (which means dP/dt is positive), then the current reference Iref is increased in the next switching cycle; if the latch dP/dt is logic low (which means dP/dt is negative), then the current reference Iref is decreased in the next switching cycle.

3. The apparatus of claim 2, wherein the ‘Control Incremental Circuit’ is implemented with the circuit shown in FIG. 6. The increased or decreased Iref value for the next switching cycle is limited to a very small value. The limitation of the step size is implemented using the op-amp circuit shown in FIG. 6. The capacitor C1 in FIG. 6 is used to set the level of the change.

4. The apparatus of claim 1, wherein the maximum power point tracking circuit is integrated into an integrated circuit.

5. The apparatus of claim 4, wherein the integrated circuit includes the switching control circuit.

6. The apparatus of claim 5., wherein the included switching control is composed of a hysteretic comparator circuit and a maximum off-time circuit, as shown in FIG. 8.

7. The apparatus of claim 5, wherein the included switching control circuit is disabled, and external switching control circuit with other switching pattern is used instead.
